(19) United States
(12) Patent Application Publication
(10) Pub. No.: US 2023/0130086 A1
(43) Pub. Date: Apr. 27, 2023

(54) SYSTEM, DEVICES AND/OR PROCESSES FOR MODIFYING ELECTRONIC CONTRACTS

(71) Applicant: Arm Limited, Cambridge (GB)

(72) Inventor: Manish Verma, Milton (GB)

(21) Appl. No.: 17/512,426

(22) Filed: Oct. 27, 2021

(51) Int. Cl. G06Q 30/00; G06Q 10/06

(52) U.S. Cl. CPC G06Q 30/01; G06Q 10/0631; G06Q 2220/00

(57) ABSTRACT

Example methods, apparatuses, and/or articles of manufacture are disclosed that may be implemented, in whole or in part, using one or more computing devices to deploy smart contract images in a blockchain. In a particular implementation, a graph may be used to identify agreements for which deployment of an updated smart contract may be avoided if the identified agreements are unaffected by a modification of an associated agreements.

### BACKGROUND

### 1. Field

The present disclosure relates generally to electronic transactions.

### 2. Information

Blockchain technology, and other technologies implemented on the Internet, have enabled electronic transactions and promise improvements in efficiency and security of business arrangements between and/or among parties. In particular, smart contracts have enabled efficient and reliable execution of business arrangements employing electronic messaging to facilitate transactions under existing agreements.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1A is a diagram illustrating relationships between and/or among agreements according to an embodiment;

FIG. 1B is a schematic diagram showing features of a smart contract, according to an embodiment;

FIG. 2 is a flow diagram of a process of creating and modifying a smart contract according to an embodiment;

FIGS. 3, 4A and 4B are diagrams of graphs illustrating relationships among agreements to be executed using electronic transactions according to embodiments;

FIG. 5 is a flow diagram of a process 500 to deploy one or more updated smart contract images in a blockchain to affect execution of one or more agreements according to an embodiment.

FIG. 6 is a flow diagram of a process to update a smart contract image in a particular example use case according to an embodiment; and

FIG. 7 is a schematic block diagram of an example computing system in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As pointed out above, blockchain technology, and other technologies implemented on the Internet, have enabled electronic transactions and promise improvements in efficiency and security of business arrangements between and/or among parties. In this context, a “blockchain” as referred to herein means a shared, immutable electronic ledger that facilitates a process of recording transactions and tracking assets in an electronic communication network. In an example implementation of a blockchain, an asset may be tangible (a house, car, cash, land) or intangible (intellectual property rights). A blockchain network may enable reliable and low-cost tracking of assets and trading between and/or among parties to transactions. A blockchain may enable immediate, shared and transparent transaction parameters stored on an immutable ledger that are accessible by permissioned network members. In particular implementations, a blockchain network may track orders, payments, accounts, production, just to provide a few examples.

While features of an existing blockchain may be immutable, a blockchain may evolve through concatenation of cryptographic objects or “blocks.” Such a block may contain a cryptographic hash of a previous block in a blockchain, a timestamp, and transaction parameters (e.g., represented as a Merkle tree). Such a timestamp may prove that particular transaction parameters existed when an associated block was deployed/published. A block concatenated to a blockchain may contain descriptors of one or more blocks previously concatenated to the blockchain such that any particular block in the blockchain may reinforce previously concatenated blocks. Features of a blockchain are resistant to modification because once recorded, such features in a given block may not be altered retroactively without altering all subsequent blocks.

According to an embodiment, features within a block (e.g., transactions) may, for example, be validated by particular network nodes known as mining nodes or “miners.” For example, such a miner may at least in part validate a block by determining a correct solution to a mathematical problem or puzzle via repeated cryptographic hashing operations. As referred to herein, blockchain “mining” or simply “mining” means a process of validating a features of a block by a mining node or “miner,” such as for inclusion in a blockchain, for example, via solving a blockchain problem or puzzle. In an embodiment, validation of a candidate block for concatenation with a blockchain may occur according to a consensus algorithm or approach. Such a consensus algorithm or approach may be developed, at least in part, on blockchain design tradeoffs.

A smart contract may provide one particular feature that may be implemented in a blockchain to facilitate transactions between and/or among parties. As referred to herein, a “smart contract” is to mean a computing program stored on a blockchain that is executable according to terms and/or conditions specified in an agreement between and/or among parties. In a particular implementation, a smart contract may facilitate an electronically automated execution of an agreement to enable an immediate notice to parties of the agreement (e.g., of particular events relating to the agreement). A smart contract may also enable an automation of workflow, triggering subsequent action responsive to particular specified conditions.

Particular agreements between and/or among parties may evolve and/or be modified, such as in on-going agreements between and/or among parties in a supply chain. Such an agreement between and/or among parties may executed, at least in part, according to one or more smart contracts deployed in a blockchain. Given an immutability of an existing smart contract in a blockchain, modification of an underlying agreement may entail implementation of a new and/or updated smart contract. Such implementation of a new and/or updated smart contract may further entail a computationally intensive process of validating (e.g., by miners) such a new and/or updated smart contract as well as re-validating blocks providing a ledger of previous transactions under such an existing smart contract. Such a computationally intensive process may be performed in addition to computations performed to validate such an existing smart contract in (and any blocks concatenated to the existing smart contract in a blockchain).

Briefly, one particular embodiment is directed to a method comprising: A method comprising: detecting modification to a term and/or condition of an agreement among a plurality of agreements, the plurality of agreements being executed by an associated plurality of smart contract images deployed in a blockchain, the plurality of agreements being associated according to a graph to express inter-dependencies of terms and/or conditions between and/or among the plurality of agreements; and identifying at least one of the plurality of agreements having terms and/or conditions unaffected by the modification based, at least in part, on the graph. The may enable, for example, deployment of updated smart contract images to execute one or more agreements affected by the modification without deployment of updated smart contract images to execute the at least one of the plurality of agreements identified as being unaffected by the detected modification. This may avoid unnecessary use or resources to validate and/or deploy a smart contract image to execute such an unaffected agreement

As pointed out above, a contractual arrangement between and/or among parties may evolve in the normal course of relationships between and/or among such parties. For example, parties to such a contractual agreement may agree to modify terms of the contractual agreement. Such a modification to a written contractual agreement may be memorialized by a written agreement to modify the contractual agreement. Also, execution of terms of in an agreement may be affected and/or altered based, at least in part, on specific facts that may be set forth in exogenous documents. For example, a contract that is ancillary contract to an existing master agreement may be defined, at least in part, by facts, terms and/or conditions set out in such an existing master agreement.

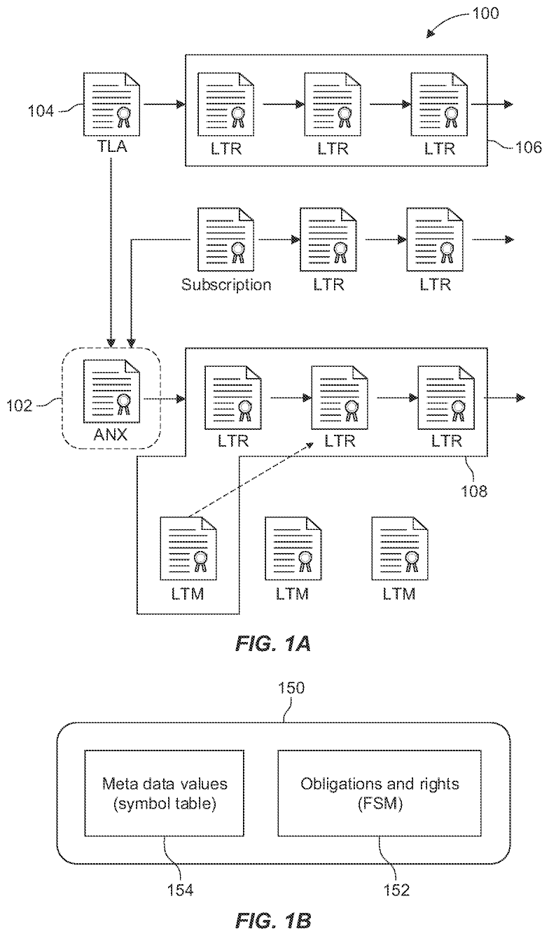

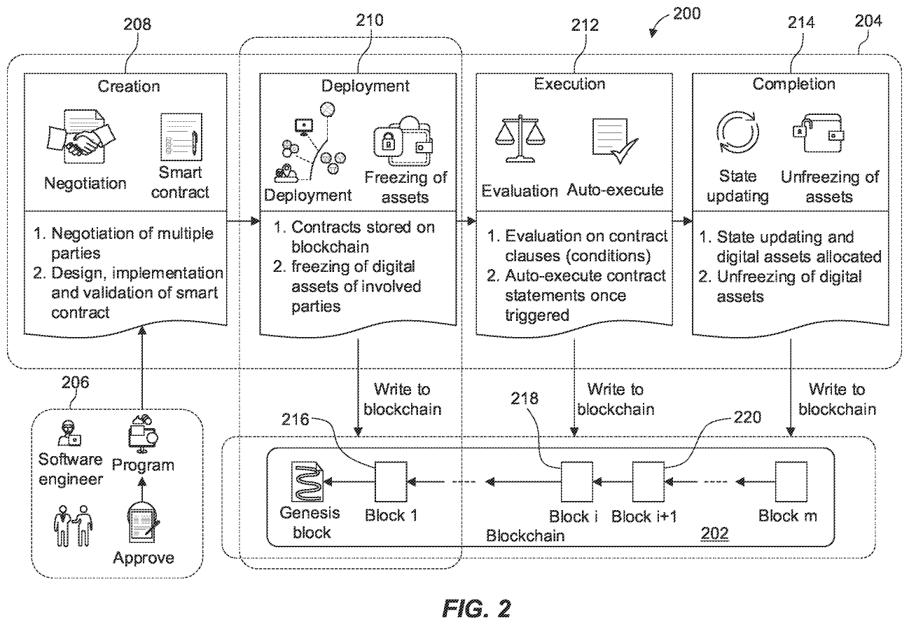

In one particular implementation, related agreements 100 expressed in a graph shown in FIG. 1A may collectively specify an arrangement between and/or among parties in a supply chain, for example. An executed master agreement 104 may be modified over a series of executed modifications 106 to affect terms and/or conditions of master agreement 104. Also, terms of a subsequent ancillary agreement 102 may be defined, at least in part, by terms, conditions and/or facts set out in master agreement 104. Ancillary agreement 102 may be further modified by a series of modifications 108 applied to ancillary agreement 102.

FIG. 1B is a schematic diagram showing features of a smart contract image 150, according to an embodiment. Obligations and rights 152 may comprise a codification of terms and conditions of an underlying agreement expressed as instructions that are executable by a computing device based on conditions, events and/or metadata values 154, for example. As pointed out above, smart contract image 150 may be deployed in an immutable blockchain that may be expressed as signals and/or states stored in a non-transitory storage medium. In an implementation, terms and conditions of master agreement 104 may be carried out via execution of a smart contract based on deployment of smart contract image 150 in a block chain. According to an embodiment, terms and conditions of ancillary agreement 102 may be carried out via execution of a separate smart contract based on a smart contract image that is separately deployed in the blockchain. For example, such a separately deployed smart contract image may incorporate obligations and rights 152, and metadata values 154 of a smart contract image to execute master agreement 104 while including additional features that are specific to terms and conditions of ancillary agreement 102. In an embodiment, deployment of separate/different blocks on a blockchain for smart contract images for separate master agreement 104 and ancillary agreement 102 may entail separate validation processes by miners, for example.

If terms of master agreement 104 are be modified, a smart contract image deployed in a blockchain to execute master agreement 104 may be redeployed to reflect modified terms. Such a redeployment of a smart contract image may entail repetition of a process to validate blockchain blocks for the redeployed smart contract image. If, for example, such a modification of master agreement 104 occurs following deployment of a smart contract image to execute ancillary agreement 102, such a smart contract image to execute ancillary agreement 102 may be redeployed. For example, if modification of terms and conditions of master agreement 104 were to affect terms and conditions of ancillary agreement 102, an updated smart contract image to execute ancillary agreement 102 may be redeployed with an associated repetition of a process to validate blockchain blocks.

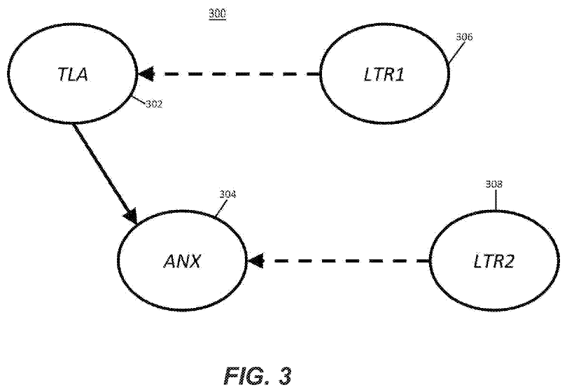

FIG. 2 is a flow diagram of a process 200 to deploy a smart contract in a blockchain 202 according to an evolution of a contractual arrangement underlying the smart contract. At block 206, parties may conclude an agreement that specifies initial terms and conditions as of an effective date of the agreement. With assistance of software engineering personnel, for example, features of a smart contract may be created at 208 which may include, for example, computer-executable instructions to express obligations and rights of a contractual arrangement and express related metadata values. As pointed out above, such features of a smart contract created at block 208 may be validated by miners according to a consensus algorithm or approach, for example. A smart contract image of a smart contract validated at block 208 may be deployed in blockchain 202 at 210 by, for example, storing such a smart contract image as block 216 in an electronic document comprising blockchain 202. As such, execution of terms and conditions of an agreement underlying a smart contract deployed in blockchain 202 at 210 may then be “frozen in place.”

As pointed out above, a smart contract deployed in block 216 may be automatically triggered to execute in response to events and/or conditions (e.g., electronic transactions) relating to an underlying agreement between and/or among parties. Here, such a deployed smart contract may automatically execute responsive to conditions and/or events at 212 that are expressed in block 218 that is written to blockchain 202. In response, such an automatic execution of a smart contract deployed in block 214 may entail a writing at 212 of block 220 to, for example, record a transaction to a ledger to be maintained in blockchain 202.

According to an embodiment, parties to a contractual arrangement expressed in a smart contract deployed in block 216 may desire and/or agree to a change to a such a contractual arrangement (e.g., modification of the contractual arrangement and/or modification of a master agreement at least in part defining an ancillary agreement expressed by a smart contract). Since blocks in blockchain 202 are immutable, features of a smart contract deployed in block 216 to bring such a change into effect (e.g., metadata values 154 defining terms and/or obligations and rights 152, FIG. 1B) cannot be modified.

As pointed out above, a modification to a contractual arrangement expressed in an original smart contract deployed in a blockchain may be effected by concatenating additional objects to the blockchain according to a graph. For example, modification of such a contractual arrangement may be effected by a deployment of blocks containing an updated smart contract image reflecting the modified contractual arrangement. If such a modification to the contractual arrangement is to affect any ancillary contractual arrangements that are executed by any associated smart contract images deployed in the blockchain, updated smart contract images to execute affected ancillary contractual arrangements may be deployed in the blockchain.

According to an embodiment, terms and conditions of multiple ancillary agreements may be based, at least in part, on terms and conditions of a master agreement. In one particular implementation, modification of terms and conditions of such a master agreement may initiate deployment in a blockchain of an updated smart contract image to execute the master agreement. Similarly, such modification of terms and conditions of the master agreement may initiate deployment in the blockchain of updated smart contract images associated with all agreements ancillary to the master agreement, even if terms and conditions of one or more of the ancillary agreements are unaffected by modification to terms and conditions of the master agreement. Here, deployment of an updated smart contract image to execute terms and conditions of such an unaffected ancillary agreement may incur unnecessary costs associated with validation (e.g., by miners) and/or deployment of such an updated smart contract image to execute the unaffected ancillary agreement. According to an embodiment, deployment in a blockchain of updated smart contract images may be limited to those smart contract images that are affected by changes to terms and conditions of a master agreement. Unnecessary deployment of updated smart contract images to execute unaffected ancillary agreements may then be avoided (e.g., reducing associated processes to validate blocks for deployment of blocks to address a modification of terms and conditions to a master agreement).

In the particular non-limiting embodiments described above with reference to FIGS. 1A and 2, aspects of an agreement between and/or among parties are to be executed by a smart contract deployed in a blockchain. In an alternative implementation, such aspects of an agreement between and/or among parties may be executed by an enterprise resource planning (ERP) system in lieu of a smart contract deployed in a blockchain.

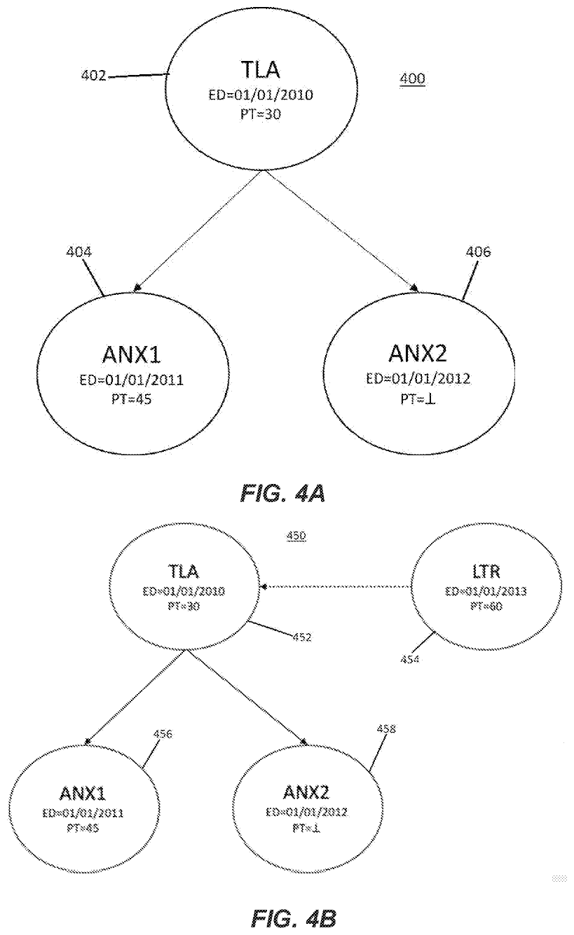

According to an embodiment, graph operations may be used to identify particular smart contract images in a blockchain that are affected by a modification to an associated master agreement. Smart contract images deployed for execution of ancillary agreements unaffected by such a modification to an associated master agreement need not be redeployed in the blockchain. FIGS. 3, 4A and 4B are diagrams of graphs 300, 400 and 450 illustrating relationships among agreements to be executed using electronic transactions according to embodiments. In particular implementations, nodes of graph 300, 400 and/or 450 may represent smart contracts deployed in a blockchain.

According to an embodiment, an edge connecting nodes in graphs 300, 400 and 450 may represent and/or express a relationship between agreements represented by the connected nodes. In one example, such an edge connecting nodes in graphs 300, 400 and 450 may represent or express a “borrowing” relationship in that terms and conditions of a first agreement represented by a first connected node are incorporated in a second agreement represented by a second connected node. For example, such a first agreement may comprise a master agreement between and/or among parties (e.g., master agreement 104, FIG. 1) while the second “borrowing” agreement comprises an ancillary agreement (e.g., ancillary agreement 102, FIG. 1). For example, a solid edge directed from node 302 representing a master agreement to node 304 representing an ancillary agreement may indicate that terms and conditions of the ancillary agreement are to incorporate at least some of the terms and conditions of the master agreement.

In another example, an edge connecting nodes in graphs 300, and 450 may represent or express an “amending” relationship in that terms and conditions of a first agreement represented by a first connected node are modified by a second agreement represented by a second connected node. For example, such a first agreement may comprise a master agreement between and/or among parties (e.g., master agreement 104, FIG. 1) while the second “amending” agreement comprises a modification agreement (e.g., an executed modification 106, FIG. 1). In a particular implementation, a broken edge directed from node 308 representing a modification agreement to node 304 representing an ancillary agreement indicates that terms and conditions of the ancillary agreement are to be modified by terms and conditions of the modification agreement represented by node 308. For example, a broken edge directed from node 306 representing a modification agreement to node 302 representing a master agreement indicates that terms and conditions of the master agreement are to be modified by terms and conditions of the modification agreement represented by node 306. Similarly, a broken edge directed from node 308 representing a modification agreement to node 304 representing an ancillary agreement indicates that terms and conditions of the ancillary agreement are to be modified by terms and conditions of the modification agreement represented by node 308.

In addition to expressing borrowing and amending relationships between and/or agreements represented by nodes, nodes of graphs 400 and 450 may further illustrate and/or express terms and/or conditions of such agreements as well as execution dates of such agreements. For simplicity of illustration, nodes of graphs 400 and 450 show a payment term as “PT” indicating when payment under an associated agreement is due after issuance of an invoice. It should be understood, however, that nodes of graphs in other implementations may indicate other/additional terms such as, for example, product, price, royalty rates, contract duration, delivery terms, limitation-of-liability terms, contracting parties, just to provide a few example.

As pointed out above, agreements represented by nodes of graph 400 and/or 450 may be executed, at least in part, by associated smart contract images deployed in a blockchain. According to an embodiment, operations applied to graph 400 and/or graph 450 may be used to identify agreements having terms and conditions that are unaffected by a modification agreement. This may obviate a need to deploy an updated smart contract image to execute such an agreement identified as unaffected by the modification agreement (and thereby avoid an associated costly validation for deployment of such an updated smart contract image on the blockchain).

In one particular implementation, a process to identify agreements having terms and conditions that are unaffected by a modification agreement may be executed in a sequence of two graph operations. A first graph operation may propagate facts relating to amending relationships expressed in nodes of a graph. A second graph operation to follow the first graph operation may propagate facts relating to borrowing relationships expressed in the graph. In such a first graph operation, according to an embodiment, nodes in a graph may be sorted based on effective dates of agreements represented and/or expressed by such nodes (e.g., in a table listing agreements from earliest execution date to most recent execution date). A first data-flow analysis may then be applied to nodes connected by an edge expressing an amending relationship to combine values of facts until nodes in the graph reach steady state values. In such second graph operation, nodes may be sorted again according to effective dates of agreements represented and/or expressed by the nodes. A second data-flow analysis may then be applied to nodes connected by an edge expressing a borrowing relationship to combine values of facts until nodes in the graph reach steady state values.

In the particular implementation of graph 400, payment terms expressed in 402 and 404 are 30 and 45 days, respectively. Payment term PT=⊥ in node 406 is to indicate that ancillary agreement ANX2 represented by node 406 is to incorporate a payment term specified by master agreement TLA represented by node 402. Effective dates expressed in 402, 404 and 406 are ED=01/01/2010, ED=01/01/2011 and ED=01/01/2012, respectively. Since graph 400 does not include any edges expressing an amending relationship, an initial graph operation to propagate facts based on an amending relationship may be bypassed. A graph operation to propagate facts based on borrowing relationships is illustrated in TABLE 1 below. As may be observed, entries in TABLE 1 at iterations of such a graph operation are sorted according to effective date from earliest (top row) to most recent (bottom row). Starting with a bottom row of iteration 1 in TABLE 1 (for agreement having the most recent execution date), a payment term to be borrowed by agreement ANX2 (represented by node 406) from agreement TLA (represented by node 402) PT=30 is to be propagated to agreement ANX2. In the row of iteration 1 of TABLE 1 for agreement ANX1 (agreement having the next earliest execution date before the execution date of agreement ANX2), no updated payment term is to be propagated to agreement ANX1 since ANX1 has a fixed payment term of PT=45. A graph operation set forth in TABLE 1 proceeds to an iteration 2 to reflect changes made to facts of ANX2 (represented by node 406). The graph operation of TABLE may then terminate at iteration 2, as no further changes are made to facts of any of agreements represented in graph 400.

TABLE 1

| | | Effective Date | Payment Term | |
|---|---|---|---|---|
| Iteration | Node | (ED) | (PT) | |
| Iteration #0 | TLA | Jan. 1, 2010 | 30 | |
| | ANX1 | Jan. 1, 2011 | 45 | |
| | ANX2 | Jan. 1, 2013 | ⊥ | |
| Iteration #1 | TLA | Jan. 1, 2010 | 30 | |
| | ANX1 | Jan. 1, 2011 | 45 | |
| | ANX2 | Jan. 1, 2013 | 30 | Change #1 |
| | | | | (⊥ -> 30) |
| Iteration #2 | TLA | Jan. 1, 2010 | 30 | |
| | ANX1 | Jan. 1, 2011 | 45 | |
| | ANX2 | Jan. 1, 2013 | 30 | |

In the particular implementation of graph 450, payment terms PT expressed in nodes 452, 454 and 456 are 30, 60 and 45 days, respectively. Payment term PT=⊥ in node 458 is to indicate that ancillary agreement ANX2 represented by node 458 is to incorporate a payment term specified by master agreement TLA represented by node 452.

As may be observed, node 456 indicates that ancillary agreement ANX1 has a payment of term of PT=45 days that is different and/or independent from a payment term of PT=30 days of master agreement TLA as specified in node 452. While a solid edge directed from node 452 to node 456 indicates a barrowing relationship (in which ancillary agreement ANX1 is to borrow at least some terms and conditions of master agreement TLA), the agreement represented by node 456 does not borrow a payment term from the agreement represented by node 452. A broken edge directed from node 454 to node 452 indicates an amending relationship in which modification LTR is to modify a payment term in master agreement TLA from PT=30 days to PT=60 days. Here, modification of master agreement TLA by modification LTR represented by node 454 may initiate deployment in a blockchain of an updated smart contract image (executing terms and conditions of master agreement TLA) to incorporate the PT=60 day payment term. Likewise, since node 458 indicates that ancillary agreement ANX2 is to incorporate a payment term from master agreement TLA represented by node 452, modification of master agreement TLA by modification LTR represented by node 454 may initiate deployment in a blockchain of an updated smart contract image (executing terms and conditions of ancillary agreement ANX2) to incorporate the PT=60 day payment term. Since ancillary agreement ANX1 is defined as having a payment term of PT=45 independent of any payment term specified by master agreement TLA, modification of payment terms of master agreement TLA (e.g., by modification LTR) need not initiate deployment of any updated smart contract image to execute terms and conditions of ancillary agreement ANX1.

In a first graph operation to propagate facts according to edges in graph 450 expressing amending relationships, TABLE 2 below reflects a sorting of agreements that have an amending relationship according to effective dates (earliest dates at top to most recent dates at bottom), which would be agreements TLA (expressed and/or represented by node 452) and LTR (expressed and/or represented by node 454). As shown at iteration 1 of TABLE 2, payment term PT in a row for agreement TLA is updated from PT=30 to PT=60 to be consistent with a payment term PT=60 specified by node 454. The graph operation of TABLE 2 may then terminate at iteration 2, as there are no changes made to facts to any of the agreements represented in graph 450. According to an embodiment, a process to terminate a graph operation (such as graph operations illustrated in TABLEs 1 and 2) may, by example, be implemented in part according to the following pseudocode:

```
def fixed_point(Nodes):
  iter = 1
  changed = True
  Nodes = Nodes.sort( )
  while (changed==True):
    iter = iter + 1
    changed=False
    for node in Nodes:
      node.apply_facts_from_incoming_edges( )
      if node.facts_updated( ):
    changed = True
```

TABLE 2

| | | Effective Date | Payment Term | |
|---|---|---|---|---|
| Iteration | Node | (ED) | (PT) | |
| Iteration #0 | TLA | Jan. 1, 2010 | 30 | |
| | LTR | Jan. 1, 2013 | 60 | |
| Iteration #1 | TLA | Jan. 1, 2010 | 60 | Change # 1 |
| | | | | (30 → 60) |
| | LTR | Jan. 1, 2013 | 60 | |
| Iteration #2 | TLA | Jan. 1, 2010 | 60 | |
| | LTR | Jan. 1, 2013 | 60 | |

In a second graph operation to propagate facts according to edges in graph 450 expressing borrowing relationships, TABLE 3 below reflects a sorting of agreements that have an amending relationship according to effective dates (earliest dates at top to most recent dates at bottom), which would be agreements TLA (expressed and/or represented by node 452), ANX1 (expressed and/or represented by node 456) and ANX2 (expressed and/or represented by node 458). As may be observed, a row for agreement TLA in TABLE 3 at iteration 0 reflects a change of payment term PT from 30 to 60 effected in a first graph operation illustrated in TABLE 2 above. An edge connecting nodes 452 and 458 indicates a borrowing relationship, and agreement ANX2 (represented by node 458) has a payment term PT=⊥. Iteration 1 reflects borrowing of a payment term PT=60 from agreement TLA (represented by node 452) which was updated from PT=30 to PT=60 a first graph operation illustrated in TABLE 1 above. While an edge connecting node 452 and 456 indicate a borrowing relationship between agreements TLA and ANX1, a fixed payment term of PT=45 is not affected (updated) by a payment term PT=30 of agreement TLA.

TABLE 3

| | | Effective Date | Payment Term | |
|---|---|---|---|---|
| Iteration | Node | (ED) | (PT) | |
| Iteration #0 | TLA | Jan. 1, 2010 | 60 | |
| | ANX1 | Jan. 1, 2011 | 45 | |
| | ANX2 | Jan. 1, 2012 | ⊥ | |
| Iteration #1 | TLA | Jan. 1, 2010 | 60 | |
| | ANX1 | Jan. 1, 2011 | 45 | |
| | ANX2 | Jan. 1, 2012 | 60 | Change #2 |
| | | | | (⊥ → 60) |
| Iteration #2 | TLA | Jan. 1, 2010 | 60 | |
| | ANX1 | Jan. 1, 2011 | 45 | |
| | ANX2 | Jan. 1, 2012 | 60 | |

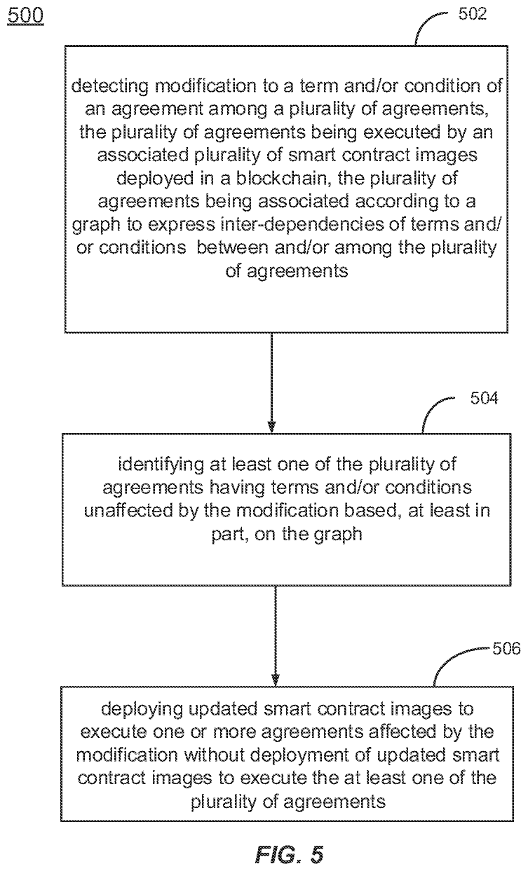

FIG. 5 is a flow diagram of a process 500 to deploy one or more updated smart contract images in a blockchain to affect execution of an agreement according to an embodiment. Block 502 may detect a modification of a term and/or condition of an agreement among a plurality of agreements being executed by an associated plurality of smart contract images deployed in a block chain. In this context, a term and/or condition in an agreement, as referred to herein, means a parameter specified in the agreement (e.g., in some written form) that affects on rights and/or obligations of one or more parties to such an agreement. In a particular implementation, the plurality of agreements may be represented as nodes in a graph that expresses inter-dependencies of terms and/or conditions between and/or among the plurality of agreements, such as how graphs 300 and 400 express borrowing and/or amending relationships between and/or among agreements represented by nodes in such a graph. In this context, the term “graph” as used herein is to mean one or more signals and/or memory states expressing agreements as nodes and expressing relationships between and/or among such agreements as edges in an electronic document. In a particular implementation, process 500 may access a graph stored in a blockchain along with smart contract to execute the plurality of agreements. Alternatively, process 500 may access a graph stored in a memory device that is extrinsic from such a blockchain.

According to an embodiment, block 502 may detect modification to a term and/or condition to an agreement responsive, at least in part, attachment of a first node in a graph to a second node in the graph by an edge that expresses an amending relationship. Applied to the particular example of FIG. 4, for example, block 502 may detect attachment of node 454 to node 452 to express a modification to a payment term as discussed above. Block 504 may identify one more agreements that are unaffected by a modification to a term and/or condition detected in block 502. Again, referring to the particular example of FIG. 4, block 504 may employ graph operations to identify ancillary agreement ANX1 represented by node 456 as being unaffected by modification to master agreement TLA expressed by an edge connecting nodes 452 and 454 as illustrated in TABLES 2 and 3.

Block 506 may comprise deploying updated smart contract images that are to execute one or more agreements affected by modification of a term and/or condition detected at block 502 without deployment of an updated smart contract image identified at block 504 as being unaffected by the modification detected at block 502. Referring again to the particular example of FIG. 4, block 506 may deploy updated smart contract image to execute master agreement TLA represented by node 452 and ancillary agreement ANX2 represented by node 456 without deployment of an updated smart contract image to execute ancillary agreement ANX1 represented by node 456. Here, identifying ancillary agreement ANX1 as being unaffected by modification master agreement TLA at block 504 may avoid use of resources to deploy and/or validate an updated smart contract image to execute ancillary agreement ANX1.

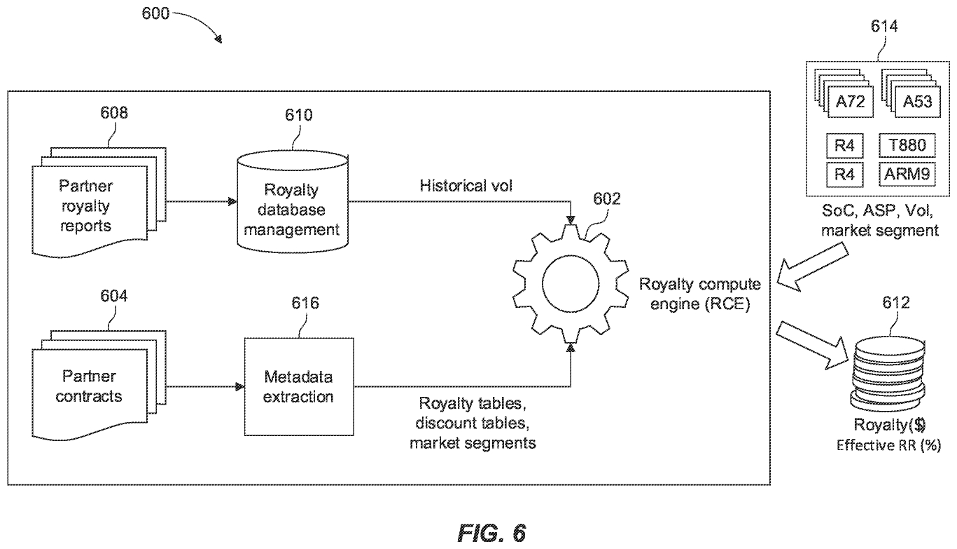

FIG. 6 is a flow diagram 600 of a use case in which an association of agreements 604 may be executed by smart contract images 602 deployed in a blockchain. In an implementation, an association of agreements 604 may comprise partner contracts setting forth terms and/or conditions for payment of royalties 612 (e.g., in exchange for use of intellectual property under a license). Smart contract images to execute individual agreements of association of agreements 604 may be deployed in a blockchain (not shown) to form royalty compute engine 602. In a particular embodiment, royalty compute engine 602 may execute deployed smart contract images to compute royalties based, at least in part, on conditions and/or events obtained from royalty database management system 610. In a particular implementation, database management system 610 may extract parameters indicative of such conditions and/or events based, at least in part, on partner royalty reports 608.

According to an embodiment, metadata extraction unit 616 may extract terms and/or conditions from association of agreements 604. According to an embodiment, metadata extraction unit 616 may maintain and/or access a graph expressing relationships between and/or among partner contracts maintain in association of agreements. In an implementation, metadata extraction unit 616 may employ graph operations to detect a modification to one or more terms and/or conditions in one or more agreements in association of agreements 604, and to determine which if such agreements are affected or unaffected by such a modification. Such terms and conditions may be in the form of royalty tables, discount tables and/or market segments, just to provide a few examples. In an embodiment, metadata extraction unit 616 may detect modification of individual agreements in association of agreements 604 based, at least in part, on changes in values and/or parameters specified in extracted royalty tables, discount tables and/or market segments. According to an embodiment, updated smart contract images may be deployed in a blockchain for royalty compute engine 602 responsive to detected changes to such values and/or parameters specified in extracted royalty tables, discount tables and/or market segments. In a particular implantation, such updated smart contract images may be deployed according to process 500 discussed above.

According to an embodiment, a current state of terms in a master agreement and/or related ancillary agreements may be maintained in a database that is accessible for queries by authorized individuals (e.g., supply chain managers). For example, such a database may capture an evolution of agreement terms resulting from application of modifications as depicted by graphs 300 and 400, and iterations shown in Table 1. In a particular implementation, an application programming interface (API) may be tailored to execute queries of such a database for results to appear on a graphical user interface (GUI) rendered on a display of a computing device. From such a GUI, an operator may initiate queries to such a database to retrieve particular items of interest relating to a particular master and/or ancillary agreement such as, for example, execution date, terms and conditions (e.g., payment terms and/or other modifiable terms and conditions), a history of modifications (e.g., identifying specific modifications and dates), links to agreements that are modified by the particular master and/or ancillary agreement, links to master agreements that define terms in the particular master and/or ancillary agreement, links to agreements that modify the particular master and/or ancillary agreement, just to provide a few examples.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public. According to an embodiment, a signal packet and/or frame may comprise all or a portion of a “message” transmitted between devices. In an implementation, a message may comprise signals and/or states expressing content to be delivered to a recipient device. For example, a message may at least in part comprise a physical signal in a transmission medium that is modulated by content that is to be stored in a non-transitory storage medium at a recipient device, and subsequently processed.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

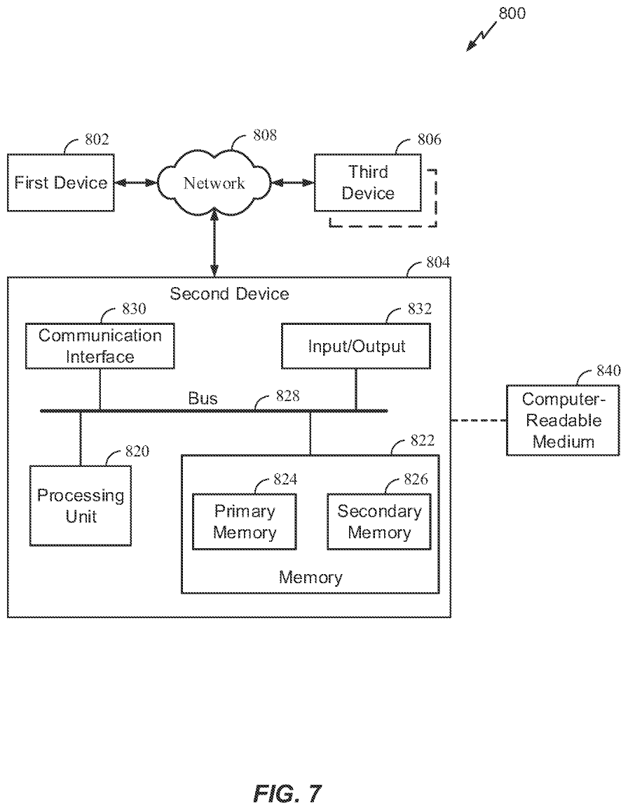

In one example embodiment, as shown in FIG. 7, a system embodiment may comprise a local network (e.g., device 804 and medium 840) and/or another type of network, such as a computing and/or communications network. For purposes of illustration, therefore, FIG. 7 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 7 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1A through FIG. 6 and in the text associated with the foregoing figure(s) of the present patent application.

Referring now to FIG. 7, in an embodiment, first and third devices 802 and 806 may be capable of rendering a graphical user interface (GUI) for a network device and/or a computing device, for example, so that a user-operator may engage in system use. Device 804 may potentially serve a similar function in this illustration. Likewise, in FIG. 7, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 7, is merely one example, and claimed subject matter is not limited in scope to this particular example. FIG. 7 may further comprise a communication interface 830 which may comprise circuitry and/or devices to facilitate transmission of messages between second device 804 and first device 802 and/or third device 806 in a physical transmission medium over network 808 using one or more network communication techniques identified herein, for example. In a particular implementation, communication interface 830 may comprise a transmitter device including devices and/or circuitry to modulate a physical signal in physical transmission medium according to a particular communication format based, at least in part, on a message that is intended for receipt by one or more recipient devices. Similarly, communication interface 830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 7, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 7 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 7, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, digital signal processors (DSPs), graphics processing units (GPUs), neural network processing units (NPUs), programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 7 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, keyboard, and/or any other similar device capable of receiving user actions and/or motions as input signals.

Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
detecting modification to a term and/or condition of an agreement among a plurality of agreements, the plurality of agreements being executed by an associated plurality of smart contract images deployed in a blockchain, the plurality of agreements being associated according to a graph to express inter-dependencies of terms and/or conditions between and/or among the plurality of agreements;
identifying at least one of the plurality of agreements having terms and/or conditions unaffected by the modification based, at least in part, on the graph; and
deploying updated smart contract images to execute one or more agreements affected by the modification without deployment of updated smart contract images to execute the at least one of the plurality of agreements.

2. The method of claim 1, wherein detecting the modification comprises determining attachment of a node to the graph, the node representing the modification.

3. The method of claim 1, wherein nodes express terms and/or conditions of agreements represented by nodes in the graph.

4. The method of claim 1, wherein identifying at least one of the plurality of agreements further comprises:
identifying the at least one of the plurality of agreements based, at least in part, on an effective agreement date, and/or at least one term and/or condition specified in a node of the graph that is associated with the at least one of the plurality of agreements.

5. The method of claim 4, wherein identifying the at least one of the one or more agreements comprises:
determining a match of a term and/or condition type of the modified term and/or condition with a term and/or condition type of the at least one term and/or condition specified in a node of the graph that is associated with the at least one of the plurality of agreements.

6. The method of claim 1, wherein the graph comprises at least one edge defining a borrowing relationship between the between the modified agreement and the identified at least one of the plurality of agreements.

7. The method of claim 1, wherein:
the agreement among the plurality of agreements comprises a master agreement, and wherein the identified at least one of the plurality of agreements comprises an ancillary agreement borrowing at least a portion of terms and/or conditions set forth in the master agreement.

8. A computing device comprising:
one or more memory devices; and
one or more processor devices coupled to the one or more memory devices to:
detect modification to a term and/or condition of an agreement among a plurality of agreements, the plurality of agreements to be executed by an associated plurality of smart contract images deployed in a blockchain, the plurality of agreements to be associated according to a graph to express inter-dependencies of terms and/or conditions between and/or among the plurality of agreements;
identify at least one of the plurality of agreements to have terms and/or conditions unaffected by the modification based, at least in part, on the graph; and
deploy at least one updated smart contract images to execute one or more agreements affected by the modification without deployment of updated smart contract images to execute the at least one of the plurality of agreements.

9. The computing device of claim 8, wherein the modification is detected based, at least in part, on determination of an attachment of a node to the graph, the node to represent the modification.

10. The computing device of claim 8, wherein nodes in the graph to express terms and/or conditions of agreements represented by nodes in the graph.

11. The computing device of claim 8, wherein the at least one of the plurality of agreements to be identified based, at least in part, on an effective agreement date, and/or at least one term and/or condition specified in a node of the graph that is associated with the at least one of the plurality of agreements.

12. The computing device of claim 11, wherein the at least one of the one or more agreements to be further identified based, at least in part, on a determination of a match of a term and/or condition type of the modified term and/or condition with a term and/or condition type of the at least one term and/or condition specified in a node of the graph that is associated with the at least one of the plurality of agreements.

13. The computing device of claim 8, wherein the graph to comprise at least one edge defining a borrowing relationship between the between the modified agreement and the identified least one of the plurality of agreements.

14. The computing device of claim 8, wherein:
the agreement among the plurality of agreements to comprise a master agreement, and wherein the identified at least one of the plurality of agreements to comprise an ancillary agreement borrowing at least a portion of terms and conditions set forth in the master agreement.

15. A method comprising:
maintaining one or more records in one or more non-transitory and computer accessible storage devices, the one or more records to express terms and/or conditions of a plurality of agreements according to a graph expressing inter-dependencies of terms and/or conditions between and/or among the plurality of agreements; and
retrieving from the records terms and/or conditions of at least one of the plurality of agreements, according to the graph.

16. The method of claim 15, wherein transactions under the plurality of agreements are executed by one or more smart contracts deployed in a blockchain.

17. The method of claim 15, wherein transactions under the agreements are executed by an enterprise resource planning system.

18. The method of claim 15, and further comprising:
updating at least one of the one or more records of to reflect a change in a term and/or condition of a first agreement of the plurality of agreements responsive to detection of modification to a term and/or condition of a second agreement of the plurality of agreements based, at least in part, on the graph.

19. The method of claim 15, wherein the graph comprises at least one edge defining a borrowing relationship between the between a modified agreement and at least one other agreement of the plurality of agreements.

20. The method of claim 15, wherein:
an agreement among the plurality of agreements comprises a master agreement, and at least one other agreement of the plurality of agreements comprises an ancillary agreement borrowing at least a portion of terms and conditions set forth in the master agreement.
